(19) United States
(12) Patent Application Publication
(10) Pub. No.: US 2016/0341643 A1
(43) Pub. Date: Nov. 24, 2016

(54) METHOD FOR FUNCTIONALLY TESTING A MEASURING INSTRUMENT

(71) Applicant: SARTORIUS LAB INSTRUMENTS GMBH & CO. KG, Goettingen (DE)

(72) Inventors: Olaf DUDDA, Goettingen (DE); Wilfried SPANNAGEL, Goettingen (DE); Daniel FAERGER, Goettingen (DE)

(21) Appl. No.: 15/231,028

(22) Filed: Aug. 8, 2016

(30) Foreign Application Priority Data
Feb. 6, 2014 (DE) 10 2014 101 462.6

(51) Int. Cl. G01N 5/04; G01M 99/00

(52) U.S. Cl. CPC G01N 5/045; G01M 99/008

(57) ABSTRACT

A method for functionally testing a measuring instrument (10) for gravimetrically determining the moisture content of a material. The method includes positioning a sample to be measured (50) on a load receiver (40), heating the sample according to a predefined monotonic heating profile, determining a weight profile of the sample by measuring at least two weight values at different times, at least one of which is measured during the heating, extracting a test value from the determined weight profile, and comparing the test value with a stored reference value. The weight profile is determined by measuring a plurality of weight values at different times during the heating, and the magnitude of the gradient of a straight line segment, which is representative of a characteristic test region (160) of the weight profile, is determined as the test value. The reference value is an expected gradient value for the sample.

### CROSS REFERENCE TO RELATED APPLICATIONS

This is a Continuation of International Application PCT/EP2015/000052, which has an international filing date of Jan. 14, 2015, and the disclosure of which is incorporated in its entirety into the present Continuation by reference. The following disclosure is also based on and claims the benefit of and priority under 35 U.S.C. §119(a) to German Patent Application No. DE 10 2014 101 462.6, filed Feb. 6, 2014, which is also incorporated in its entirety into the present Continuation by reference.

### FIELD OF THE INVENTION

The invention relates to a method for functionally testing a measuring instrument, which is configured to gravimetrically determine the moisture content of a material and that comprises a weighing device and a heating device configured to heat a measurement sample that is positioned on a load receiver, said method comprising:
positioning a measurement sample, which can be dried by heating with the heating device, on the load receiver,
heating the sample according to a predefined monotonic heating profile,
determining a weight profile of the sample by measuring at least two weight values at different times, at least one of which is measured during the heating,
extracting a test value from the determined weight profile,
comparing the test value with a stored reference value.

### BACKGROUND

In practice the relative moisture content of a sample material is often determined by gravimetric analysis with the aid of measuring instruments, which consist of a combination of a heating device and a weighing device. To the user of such measuring instruments it is of interest to check the functionality of these two components simultaneously. This is often done using so-called reference samples, of which the moisture content and the drying characteristics for different heating parameters are found once by experiment. These properties of the reference sample are, as explained below, essential for the function test and must, therefore, be either acquired immediately before the actual function test or preserved in the period between their acquisition and the actual implementation of the function test.

One method for functionally testing a measuring instrument for gravimetrically determining the moisture content of a material (hereinafter referred to in brief as the measuring instrument) is known, for example, from the European patent EP 2 442 091 A1. In this method the initial weight of a sample to be measured, i.e., a reference sample, is determined in the way described above; the test compartment is heated by a predefined temperature profile; and then the weight of the reference sample is determined again as the test value. By comparing the test value with a reference value, which is stored in a memory, it is possible in this way to make a statement about the functionality of the measuring instrument. In this context the reference value is a weight value that has been generated under standardized conditions for a measurement sample that is identical to the current reference sample. If the difference between the test value and the reference value is within the specified tolerances, then the result of the function test of the measuring instrument is positive. That is, the measuring instrument is working with sufficient accuracy. However, the measuring instrument is not working accurately, if the determined difference is outside the specified tolerances. Hence, the result of the function test is negative. In this case the specific reference value for a given reference sample is linked by the initial weight with the reference sample (sameness of the remaining properties, in particular, the moisture content is tacitly assumed). As a result, determining the initial weight of the reference sample would make it possible to draw an immediate conclusion about the corresponding reference value.

At the same time, however, linking the reference value with the initial weight of the reference sample, i.e., its identification on the basis of its initial weight, is also a major problem of the prior art method for functionally testing this type of measuring instrument. This is true, in particular, in the context of the storage periods that are sometimes extremely long for the reference samples and that may occur between the individual test intervals and may lead to a change in the relevant properties in the event that insufficient preservation steps, in particular, packaging steps are taken. It would be desirable if the storage-induced changes in the sample to be measured did not have an effect on the function test method; in other words, if no well-defined reference samples, as specified above, were required. However, this is not the case with the methods known to date. In particular, in the prior art methods any variation in the composition of the sample to be measured, for example, variations that occur during storage, such as, for example, variations due to the evaporation of volatile components, would result in incorrect reference values because of the associated variations in the starting material and, therefore, would result in significant inaccuracies with regard to the function test. The attempts to eliminate this problem have been limited to date, as described in the European patent EP 2 442 091 A1, to constructing the packaging of the reference samples in such a way that no change in the starting material will occur over the storage period. However, this approach is associated with considerable cost and effort. The patent EP 2 442 091 A1 also describes the possibility of not linking the reference value with the initial weight, but rather with a weight that is a function of the temperature profile. However, this reference weight is a direct function of the initial weight, so that the aforementioned problem relating to the incorrect reference values cannot be solved even in this way.

### SUMMARY

One object of the present invention is to further develop such a method for functionally testing a measuring instrument, which is configured to gravimetrically determine the moisture content of a material, in such a way that the function test can be carried out independently of the determination of a specific reference weight. This object is achieved in conjunction with the features, disclosed in the preamble of the independent claim, by the fact that the weight profile is determined by measuring a plurality of weight values at different times during the heating, and that the magnitude of the gradient of a straight line segment, which represents a characteristic test region of the weight profile, is determined as the test value.

Preferred embodiments of the function test method are the subject matter of the dependent claims.

In order to carry out the function test method according to the invention, a sample to be measured is positioned on the load receiver, heated with a monotonic heating profile, that is, the heating by the heating device is not interrupted during the heating process, and the weight profile is determined. In this case the determination of the weight profile from the measured weight values may be conducted, for example, by acquiring the weight values as a function of the heating time. However, the person skilled in the art still has a number of other options for determining the weight profile. For example, the weight values can also be specified as a relative moisture content of the sample to be measured; or the weight values or, more specifically, the moisture content values can also be acquired, in addition to the heating time, as a function of a suitable temperature. This temperature may be, for example, the temperature of a test chamber, in which the sample to be measured is located, where in this case the temperature of said test chamber has been increased by heating it.

In order to implement the invention, it is preferably provided that a regression function is determined from the weight profile; the weight profile is divided into partial weight profiles; and the characteristic test region is formed by at least one partial weight profile, for which the gradients of the regression function exhibit a magnitude that is greater than or equal to a minimum gradient value. The determination of the regression function can be performed, for example, in such a way that the sum of all distances or the squared distances of the points of the weight profile for the regression function is minimal. However, it is also possible to determine first an auxiliary function that accurately describes all of the points of the weight profile and then to determine a regression function, with which all of the local maxima or minima of the auxiliary function can be described. It is advantageous if the straight line segment, which is representative of the characteristic test region of the weight profile, exhibits in terms of magnitude a steep gradient, since this increases the accuracy of the determined test value. For this reason it is provided that the test value is extracted only from those partial weight profiles, for which the gradients of the regression function exhibit a magnitude that is greater than or equal to the minimum gradient value. In this case these partial weight profiles form the characteristic test region. Then the test value can be determined, for example, with a linear compensation function from all of the weight profile points of the characteristic test region. In this case the linear compensation function represents the straight line segment, which is representative of the characteristic test region, so that the magnitude of the gradient of the linear compensation function forms the test value. At the same time the linear compensation function can be selected, for example, in such a way that the sum of all distances or the squared distances of the weight profile points of the characteristic test region for the linear compensation function is minimal.

The invention is characterized by the feature that the test value is extracted from the weight profile only indirectly, i.e., in the form of the magnitude of the gradient of a representative straight line segment. This indirect extraction is extremely advantageous, since the magnitude of this gradient represents a suitable test value for the function test of the measuring instrument, yet is independent of a specific reference weight. In this way the inventive method makes it possible to carry out the function test with a measurement sample of any initial weight. As a result, the function test of the measuring instrument can be conducted without any of the above described complications relating to the variation in the sample to be measured due to storage. In this respect the sample to be measured can be, for example, a packaged or unpackaged hydrogel synthesized from water, glycerin and polymers.

In an alternative embodiment of the invention it is provided that an inflection point of a regression function, which is determined from the weight profile, is determined; the weight profile is divided into partial weight profiles; and the characteristic test region is formed by a partial weight profile, which has limits that are distributed symmetrically about the point of inflection. As a result, a suitable characteristic test region, i.e., a characteristic test region, from which it is possible to extract a test value that in terms of absolute value is as large as possible and, thus, as accurate as possible, is identified in an advantageous manner using the inflection point of the regression function. Another feature of this embodiment is that the test region limits are arranged symmetrically about the point of inflection. Therefore, starting from the point of inflection, it suffices to check only the conditions for positioning one test region limit. For example, the magnitude of the gradient of the regression function could be determined; and the first test region limit could be defined as soon as this magnitude falls below a minimum gradient value. Then in order to position another test region limit, it would no longer be necessary to check the positioning conditions, since the positioning can be done based on the symmetrical relationship to the first test region limit.

In an additional alternative embodiment of the invention it is provided that the maximum amount of a gradient of a regression function that is determined from the weight profile is used as the test value. In this way it is possible to dispense completely with a division of the weight profile into partial weight profiles. Instead, it suffices to create a regression function based on the weight profile, to analyze the gradient profile of the regression function and to extract the test value on the basis of this analysis. In this case the region of the weight profile, for which the regression function has been determined, represents the characteristic test region; and a gradient straight line through the point of the absolute maximum gradient of the regression function represents the representative straight line segment.

An additional alternative embodiment of the invention provides that the weight profile is divided into partial weight profiles; and for each partial weight profile the gradient of a representative straight line is determined on the basis on the weight values of this partial weight profile, with the size of the partial weight profiles being selected in such a way that the gradients of the representative straight line have the same sign (plus or minus), and the maximum amount of the gradients of the representative straight line is used as the test value. The condition that the size of the weight profiles be selected in such a way that the gradients of the representative straight line have the same sign (plus or minus) is advantageous because the weight profile may be subject to noise at sufficient resolution, i.e., with a sufficiently sensitive determination of the weight values. Therefore, too small a choice of the partial weight profiles will result in different gradient signs (plus or minus) for the adjacent partial weight profiles. This special condition ensures that the characteristic test region, which in this case is the partial weight profile having a representative straight line that exhibits the absolute maximum gradient, is characteristic of the weight profile.

In an alternative embodiment of the invention it is provided that the weight profile is divided into partial weight profiles; and for each partial weight profile the gradient of a representative straight line is determined based on the weight values of this partial weight profile, with the size of the partial weight profiles being selected in such a way that the gradients of the representative straight line have the same sign (plus or minus), and the characteristic test region is formed by at least one partial weight profile, for which the gradient of a representative straight line has a magnitude that is greater than or equal to a minimum gradient value. This embodiment is advantageous, since the minimum gradient value can be used to vary the size of the characteristic test region. In this case a larger characteristic test region, i.e., a characteristic test region that is formed by a larger number of partial weight profiles, would provide a statistically safer test value than a small characteristic test region, whereas in a small characteristic test region a smaller linearization error is to be expected in determining the representative straight line segment. Thus, the minimum gradient value makes it possible to adapt the function test method to the requirements needed in each case.

The mathematical methods and processes for this purpose are known to the person skilled in the art and, therefore, require no further explanation.

Other features and advantages of the invention will become apparent from the following specific description and the drawings.

### BRIEF DESCRIPTION OF THE DRAWINGS

The drawings show in:

FIG. 1: a diagrammatic representation of a measuring instrument that is suitable for carrying out the function test method of the invention.

FIG. 2: an illustration of an embodiment of the function test method of the invention.

### DETAILED DESCRIPTION

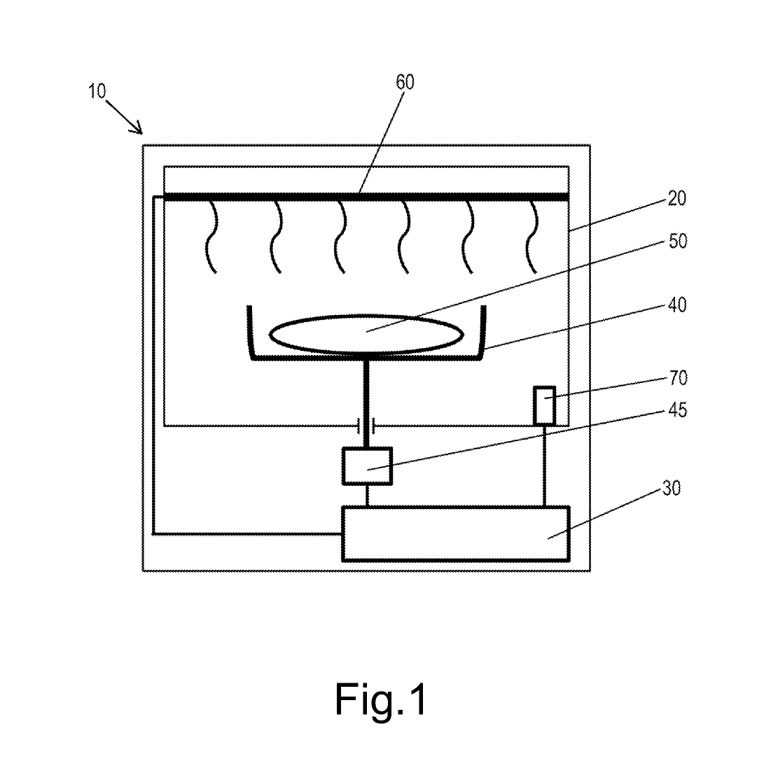

FIG. 1 shows a measuring instrument 10 that is equipped with a test chamber 20 and a control unit 30. Inside the test chamber 20 a sample to be measured 50 is positioned on a load receiver 40; and said sample to be measured can be heated with a heating device 60, such as, for example, an infrared radiant heater. In addition, there is a temperature sensor 70 in the test chamber 20. Furthermore, the drawing also shows that the control unit 30 is fed the weight measuring signal of a weighing unit 45 and the temperature signal of the temperature sensor 70; and the control unit 30 is able to control the heating device 60. The control unit 30 is able to process these incoming and outgoing signals. This approach allows the control unit 30 to initiate the heating of the sample to be measured 50 by the heating device 60 and to determine the weight profile, on the basis of the weighing signal and the temperature signal. As an alternative, this weight profile can also be determined only on the basis of the weighing signal. This is possible, since the heating of the sample to be measured is started by the control unit 30; and, as a result, this control unit can determine a weight profile based on the weighing signal and the time that has elapsed since the initiation of the heating process. In this embodiment, which is shown merely for illustrative purposes, the weighing device consists of the load receiver 40 and the weighing unit 45.

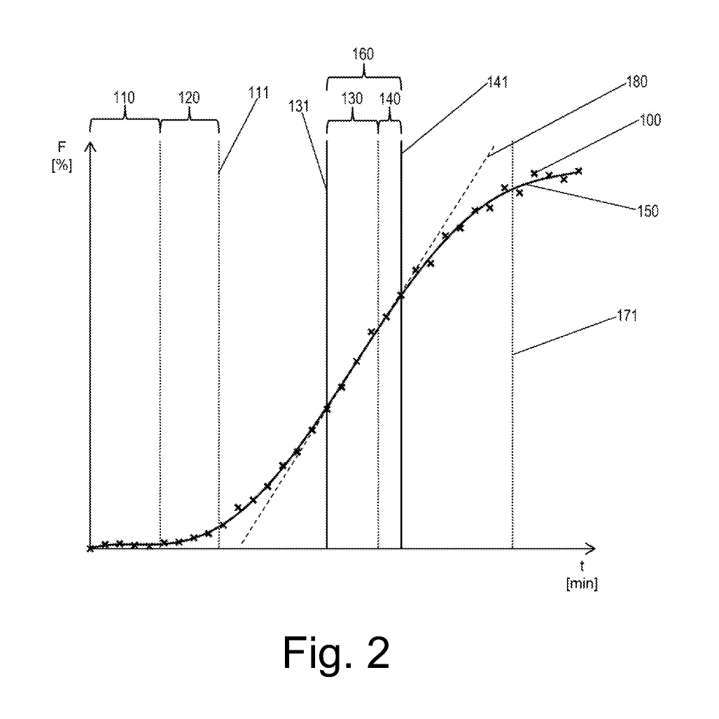

FIG. 2 shows, by way of an example, an illustration of a weight profile, which is constructed from the weight profile points 100. In this case the weight profile points 100 have been generated from the weight values that were determined at different times during the heating. In this case the relative moisture loss values F were determined from the measured weight values and plotted against the time t that has elapsed since the initiation of the heating. Furthermore, FIG. 2 shows the division of the weight profile into partial weight profiles 110, 120, 130, 140, as well as a regression function 150 that is calculated from the weight profile. The gradients of the regression function 150 are greater than or equal to a predetermined minimum gradient value in the region of the partial weight profiles 130 and 140. For this reason the characteristic test region 160 is formed by these partial weight profiles. Therefore, in this case the partial weight profile limits 131, 141 form the limits of the characteristic test region 160, where for illustrative purposes the limits are shown as altered with respect to the other partial weight profile limits 111, 171, which are depicted in FIG. 2. In addition, FIG. 2 also shows an illustration of a linear compensation function 180, which has been generated based on the weight profile points that may be found in the characteristic test region 160. In this case the magnitude of the gradient of this compensation function represents the test value. By comparing this test value with a previously determined reference value, it is possible to make a statement about the functionality of the measuring instrument. For this purpose the reference value is taken from a reference value table, which is stored in the control unit 30 and in which the gradient values, which are to be expected for the different types of samples to be measured, are stored. If the difference between the test value and the reference value is within the specified tolerances, then the function test of the measuring instrument is positive. That is, the measuring instrument works with sufficient accuracy.

The embodiments discussed in the specific description and shown in the figures, are illustrative, exemplary embodiments of the present invention. From the disclosure given, those skilled in the art will not only understand the present invention and its attendant advantages, but will also find apparent various changes and modifications to the structures and methods disclosed. The applicant seeks, therefore, to cover all such changes and modifications as fall within the spirit and scope of the invention, as defined by the appended claims, and equivalents thereof.

### LIST OF REFERENCE NUMERALS

10 measuring instrument

20 test chamber

30 control unit

40 load receiver

45 weighing unit

50 sample to be measured

60 heating device

70 temperature sensor

100 weight profile points

110, 120, 130, 140 partial weight profiles

111 partial weight profile limit

131 partial weight profile limit of 130

141 partial weight profile limit of 140

150 regression function

160 characteristic test region

171 partial weight profile limit

180 linear compensation function

What is claimed is:

1. A method for functionally testing a measuring instrument which is configured to gravimetrically determine a moisture content of a material and which comprises a weighing device and a heating device configured to heat a measurement sample positioned on a load receiver,
said method comprising:
positioning the sample on the load receiver,
heating the sample according to a predefined monotonic heating profile,
determining a weight profile of the sample by measuring at least two weight values at different times, at least one of the values being measured during said heating,
extracting a test value from the determined weight profile, and
comparing the test value with a stored reference value,
wherein said determining of the weight profile comprises measuring a plurality of weight values at different times during said heating; and determining a magnitude of a gradient of a straight line segment, which represents a characteristic test region of the weight profile, as the test value;
wherein the reference value is an expected gradient value for the sample.

2. The method as claimed in claim 1, further comprising:
determining a regression function from the weight profile;
dividing the weight profile into partial weight profiles; and
forming the characteristic test region from at least one partial weight profile, for which the gradients of the regression function exhibit a magnitude that is greater than or equal to a minimum gradient value.

3. The method as claimed in claim 1, further comprising:
determining an inflection point of the regression function, which is determined from the weight profile;
dividing the weight profile into partial weight profiles; and
forming the characteristic test region from a partial weight profile, which has limits distributed symmetrically about the point of inflection.

4. The method as claimed in claim 1, further comprising:
using a maximum amount of a gradient of a regression function, determined from the weight profile, as the test value.

5. The method as claimed in claim 1, further comprising:
dividing the weight profile into partial weight profiles; and
determining, for each of the partial weight profiles, the gradient of a representative straight line on the basis of the weight values of the partial weight profiles, with the size of the partial weight profiles being selected such that the gradients of the representative straight line have the same sign; and
using the maximum amount of the gradients of the representative straight line as the test value.

6. The method as claimed in claim 1, further comprising:
dividing the weight profile into partial weight profiles; and
determining, for each partial weight profile, the gradient of a representative straight line based on the weight values of the partial weight profile, with the size of the partial weight profiles being selected such that the gradients of the representative straight line have the same sign; and
forming the characteristic test region from at least one partial weight profile, for which the gradient of a representative straight line has a magnitude that is greater than or equal to a minimum gradient value.
